(19) United States
(12) Patent Application Publication
(10) Pub. No.: US 2023/0315950 A1
(43) Pub. Date: Oct. 5, 2023

(54) CLEARANCE CALCULATION DEVICE AND CLEARANCE CALCULATION METHOD

(71) Applicant: MITSUBISHI HEAVY INDUSTRIES, LTD., Tokyo (JP)

(72) Inventors: Satoshi Kumagai, Tokyo (JP); Hiroki Takeda, Tokyo (JP); Yuta Imai, Tokyo (JP); Motoharu Ueda, Tokyo (JP); Masahiro Yamada, Tokyo (JP)

(73) Assignee: MITSUBISHI HEAVY INDUSTRIES, LTD., Tokyo (JP)

(21) Appl. No.: 18/186,400

(22) Filed: Mar. 20, 2023

(30) Foreign Application Priority Data
Mar. 31, 2022 (JP) 2022-059576

(51) Int. Cl. G06F 30/23; F01D 11/00

(52) U.S. Cl. CPC G06F 30/23; F01D 11/00; F05D 2260/20; G06F 2119/08

(57) ABSTRACT

A clearance calculation device for a rotary machine in which a rotating body is rotatably supported by a stationary body and a gas path is formed between the stationary body and the rotating body. The clearance calculation device includes: a data acquisition unit configured to acquire a rotational speed of the rotating body and a gas temperature of a gas taken in the gas path; a gas path temperature calculation unit configured to calculate a gas path temperature of the gas path based on the rotational speed and the gas temperature; a metal temperature calculation unit configured to calculate temperatures of the stationary body and the rotating body by performing an unsteady heat transfer analysis using a stationary body heat transfer analysis model and a rotating body heat transfer analysis model using the gas path temperature as a boundary condition; a deformation amount calculation unit configured to calculate deformation amounts of the stationary body and the rotating body based on temperature changes of the stationary body and the rotating body; and a clearance calculation unit configured to calculate a clearance value between the stationary body and the rotating body based on the deformation amounts.

### CROSS-REFERENCE TO RELATED APPLICATIONS

This application claims the benefit of priority to Japanese Patent Application Number 2022-059576 filed on Mar. 31, 2022. The entire contents of the above-identified application are hereby incorporated by reference.

### TECHNICAL FIELD

The disclosure relates to a clearance calculation device and a clearance calculation method for estimating a gap (clearance) between a stationary body and a rotating body.

### RELATED ART

A gas turbine, which is a rotary machine, is made up of a compressor, a combustor, and a turbine. The compressor generates high-temperature and high-pressure compressed air by compressing air taken in the compressor. The combustor obtains high-temperature and high-pressure combustion gas by supplying fuel to the compressed air and causing the fuel and air to be combusted. The turbine is driven by the combustion gas, and drives a power generator coaxially connected to the turbine. In the turbine, a rotor is rotatably supported inside a casing. The casing includes a plurality of stator vanes fixed to an inner peripheral portion of the casing at intervals in an axial direction, and the rotor includes a plurality of rotor blades fixed to an outer peripheral portion of the rotor at intervals in the axial direction. The plurality of stator vanes of the casing and the plurality of rotor blades of the rotor are alternately arranged at intervals in the axial direction.

In recent years, with the increase in renewable energies, gas turbines have been required to respond to fluctuations in power demand by means of rapid startup, rapid load change, and the like. When operations such as rapid startup and rapid load change are performed in a gas turbine, a gap between a rotating body and a stationary body may be reduced due to thermal expansion of components, and the rotating body and the stationary body may come into contact with each other. Therefore, it is necessary to monitor the size of the gap between the rotating body and the stationary body and maintain the gap at an appropriate value.

For example, JP 2000-27606 A discloses a technique for estimating the size of a gap between a rotating body and a stationary body.

### SUMMARY

In the technique disclosed in JP 2000-27606, thermal expansion of the structure of a gas turbine is obtained using temperatures and pressures at a plurality of locations in the rotating body and the stationary body, and a clearance between the rotating body and the stationary body is calculated based on the thermal expansion. In this case, a plurality of measuring instruments for measuring the temperatures and the pressures of the rotating body and the stationary body is required, and this causes a problem in that a product cost is increased and service lives of the measuring instruments must be considered for long-term use.

The disclosure has been made to solve the problem described above, and an object of the disclosure is to provide a clearance calculation device and a clearance calculation method that can suppress an increase in cost and reduce a computation load.

A clearance calculation device according to the disclosure for achieving the object described above is a clearance calculation device for a rotary machine in which a rotating body is rotatably supported by a stationary body and a gas path is formed between the stationary body and the rotating body. The clearance calculation device includes: a data acquisition unit configured to acquire a rotational speed of the rotating body and a gas temperature of a gas taken in the gas path; a gas path temperature calculation unit configured to calculate a gas path temperature of the gas path based on the rotational speed and the gas temperature; a metal temperature calculation unit configured to calculate temperatures of the stationary body and the rotating body by performing an unsteady heat transfer analysis using a stationary body heat transfer analysis model and a rotating body heat transfer analysis model using the gas path temperature as a boundary condition; a deformation amount calculation unit configured to calculate deformation amounts of the stationary body and the rotating body based on temperature changes of the stationary body and the rotating body; and a clearance calculation unit configured to calculate a clearance value between the stationary body and the rotating body based on the deformation amounts.

A clearance calculation method according to the disclosure is a clearance calculation method for a rotary machine in which a rotating body is rotatably supported by a stationary body and a gas path is formed between the stationary body and the rotating body. The clearance calculation method includes: a step of acquiring a rotational speed of the rotating body and a gas temperature of a gas taken in the gas path; a step of calculating a gas path temperature of the gas path based on the rotational speed and the gas temperature; a step of calculating temperatures of the stationary body and the rotating body by performing an unsteady heat transfer analysis using a stationary body heat transfer analysis model and a rotating body heat transfer analysis model using the gas path temperature as a boundary condition; a step of calculating deformation amounts of the stationary body and the rotating body based on temperature changes of the stationary body and the rotating body; and a step of calculating a clearance value between the stationary body and the rotating body based on the deformation amounts.

According to the clearance calculation device and the clearance calculation method of the disclosure, it is possible to suppress an increase in cost and to reduce a computation load.

### BRIEF DESCRIPTION OF DRAWINGS

The disclosure will be described with reference to the accompanying drawings, wherein like numbers reference like elements.

FIG. 1 is a schematic view illustrating the overall configuration of a gas turbine.

FIG. 2 is a cross-sectional view illustrating a gas flow path of a compressor.

FIG. 3 is a schematic configuration diagram illustrating a clearance estimation system according to a first embodiment.

FIG. 4 is a schematic diagram illustrating a low-dimensional unsteady heat transfer analysis model.

FIG. 5 is an explanatory diagram for describing an average clearance value.

FIG. 6 is a flowchart illustrating a clearance estimation method according to the first embodiment.

FIG. 7 is an explanatory diagram showing ranges of coefficients in optimization.

FIG. 8 is a schematic configuration diagram illustrating a clearance estimation system according to a second embodiment.

FIG. 9 is an explanatory diagram for describing local clearance values.

FIG. 10 is a flowchart illustrating a clearance estimation method according to the second embodiment.

FIG. 11 is a schematic configuration diagram illustrating a clearance estimation system according to a third embodiment.

FIG. 12 is a flowchart illustrating a clearance estimation method according to the third embodiment.

FIG. 13 is a graph illustrating variations in clearance according to an operation schedule.

### DESCRIPTION OF EMBODIMENTS

Hereinafter, preferred embodiments of the disclosure will be described in detail with reference to drawings. Note that the disclosure is not limited to these embodiments, and when there is a plurality of embodiments, the disclosure is intended to include a configuration combining these embodiments. In addition, components in the embodiments include those that can be easily assumed by those skilled in the art, those that are substantially the same, and those with a so-called equivalent scope.

### First Embodiment

### Gas Turbine

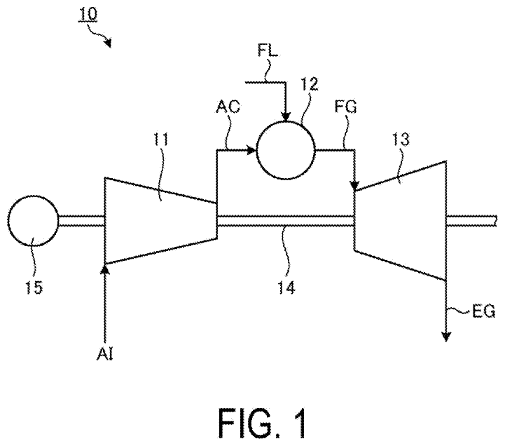

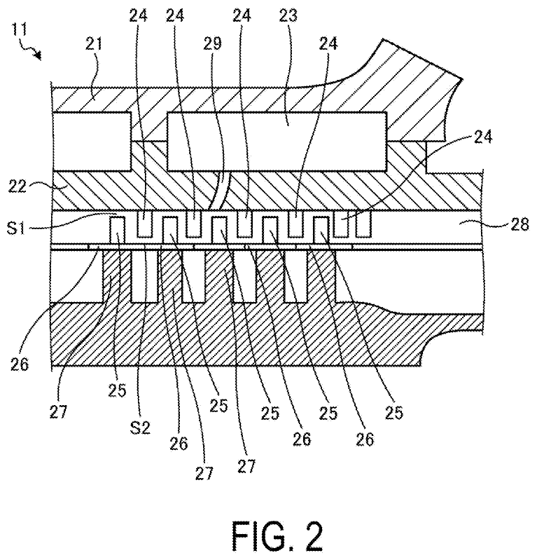

FIG. 1 is a schematic view illustrating the overall configuration of a gas turbine, and FIG. 2 is a cross-sectional view illustrating a gas flow path of a compressor.

As illustrated in FIG. 1, a gas turbine 10 includes a compressor 11, a combustor 12, and a turbine 13. The compressor 11 and the turbine 13 are integrally rotatable by a rotor 14. One end portion in an axial direction of the rotor 14 is connected to a generator 15.

In the compressor 11, generates high-temperature and high-pressure compressed air AC by compressing air AI taken in from an air intake port while the air AI passes through a plurality of stator vanes and rotor blades. The combustor 12 generates high-temperature and high-pressure combustion gas FG by supplying fuel FL to the compressed air AC and causing the fuel and the compressed air AC to be combusted. The combustion gas FG passes through the stator vanes and the rotor blades and then is discharged as exhaust gas EG from the turbine 13. The turbine 13 drives and rotates the rotor 14 by the combustion gas FG, and thereby drives the generator 15 connected to the rotor 14.

As illustrated in FIG. 2, in the compressor 11, a casing 21 constitutes a compressor casing, and an inner casing 22 is fixed to an inner side in a radial direction of the casing 21. The casing 21 and the inner casing 22 have a tube shape concentric with the rotor 14, and an extracted air chamber 23 is formed between the casing 21 and the inner casing 22. The rotor 14 is rotatably supported inside the casing 21 and the inner casing 22. At the inner peripheral portion of the inner casing 22, a plurality of stator vanes 24 is arranged at intervals in the circumferential direction of the rotor 14 and at intervals in the axial direction of the rotor 14. At the outer peripheral portion of the rotor 14, a plurality of rotor blades 25 is arranged at intervals in the circumferential direction of the rotor 14 and at intervals in the axial direction of the rotor 14. The plurality of stator vanes 24 on the casing 21 side and the plurality of rotor blades 25 on the rotor 14 side are alternately arranged at intervals in the axial direction of the rotor 14.

The plurality of stator vanes 24 is arranged at intervals in the circumferential direction, and each of the stator vanes 24 extends in the radial direction of the rotor 14. The base end portion of the stator vane 24 is fixed to an inner peripheral portion of the inner casing 22. The plurality of rotor blades 25 is arranged at intervals in the circumferential direction and extends along the radial direction of the rotor 14. A platform 26 is fixed to the base end portions of the rotor blades 25, and the platform 26 is fixed to an outer peripheral portion of a turbine disk 27 fixed to the rotor 14.

A gap (clearance) S1 is secured between the other end portions of the plurality of rotor blades 25 and an inside surface of the inner casing 22. A gap S2 is secured between the tip portions of the plurality of stator vanes 24 and a member on the rotor 14 side, that is, the platform 26 here.

In the compressor 11, an air passage (gas path) 28 having a ring shape is formed between the inner casing 22 and the platform 26. The inner casing 22 is provided with an extraction passage 29 communicating with the extracted air chamber 23 and the air passage 28. The plurality of stator vanes 24 and the plurality of rotor blades 25 are disposed in the air passage 28. The compressed air AC flows through the air passage 28 along the axial direction of the rotor 14.

As illustrated in FIGS. 1 and 2, when the gas turbine 10 is started, the high-temperature compressed air AC flows through the air passage 28. The plurality of stator vanes 24 and the plurality of rotor blades 25 are heated by the high-temperature compressed air AC and cause thermal expansion. Then, a clearance value of the gap S1 between the plurality of rotor blades 25 and the inner casing 22 decreases, and a clearance value of the gap S2 between the plurality of stator vanes 24 and the platform 26 decreases. When the clearance values of the gaps S1 and S2 decrease, there is a possibility that the rotor blades 25 and the inner casing 22 come into contact with each other or the stator vanes 24 and the platform 26 come into contact with each other. Thus, it is necessary to monitor the clearance values of the gaps S1 and S2 and maintain the clearance values at appropriate values.

### Clearance Estimation System

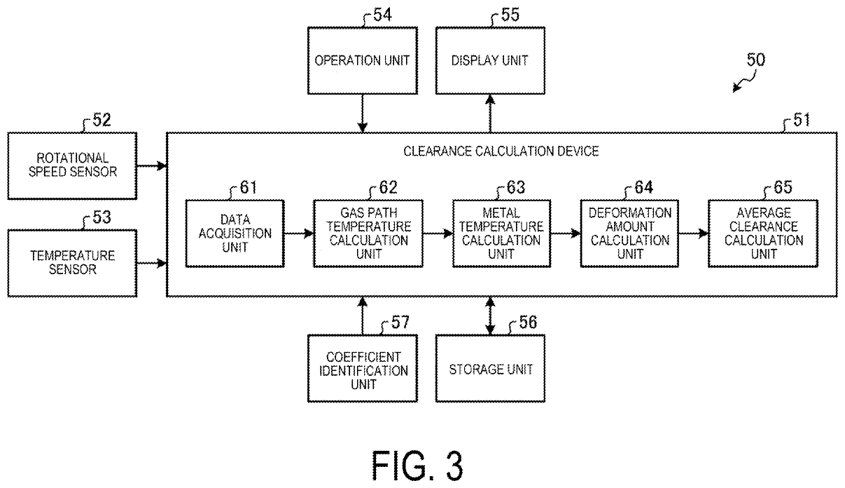

FIG. 3 is a schematic configuration diagram illustrating a clearance estimation system according to the first embodiment. In the following description, the estimation of a clearance value of the gap S1 in the compressor 11 will be described. However, the estimation of a clearance value of the gap S2 in the compressor 11 and the estimation of clearance values of the gaps S1 and S2 in the turbine 13 are substantially the same.

For the gas turbine (rotary machine) 10 in which the rotor (rotating body) 14 is rotatably supported by the casing (stationary body) 21 and the air passage (gas path) 28 is formed between the casing 21 side and the rotor 14 side, a clearance estimation system according to the first embodiment estimates the size of the gap S1, that is, the magnitude of a clearance value SC1, between the inner casing 22 on the stationary body side and the rotor blades 25 on the rotating body side in the compressor 11.

As illustrated in FIG. 3, the clearance estimation system 50 includes a clearance calculation device 51, a rotational speed sensor 52, a temperature sensor 53, an operation unit 54, a display unit 55, and a storage unit 56.

The clearance calculation device 51 calculates a clearance value SC1 of the gap S1 between the inside surface of the inner casing 22 fixed to the casing 21 and a tip surface of the rotor blade 25 fixed to the rotor 14. A specific configuration of the clearance calculation device 51 will be described later.

The clearance calculation device 51 is a control device, and the control device is a controller that is implemented, for example, by a Central Processing Unit (CPU) or a Micro Processing Unit (MPU) executing various types of programs stored in the storage unit by using a RAM as a work area.

The rotational speed sensor 52 is disposed, for example, at the casing 21, and measures a rotational speed of the rotor 14. The temperature sensor 53 is disposed, for example, at the casing 21, and measures an intake gas temperature of intake gas taken in by the compressor 11 of the gas turbine 10. The rotational speed sensor 52 and the temperature sensor 53 are connected to the clearance calculation device 51, and output the measured rotational speed and the measured intake gas temperature to the clearance calculation device 51.

The operation unit 54 is connected to the clearance calculation device 51. The operation unit 54 can be operated by an operator. When operated by an operator, the operation unit 54 can input various types of command signals to the clearance calculation device 51. The operation unit 54 is, for example, a keyboard or a touch display.

The display unit 55 is connected to the clearance calculation device 51. The display unit 55 displays the clearance value SC1 of the gap S1 calculated by the clearance calculation device 51. The display unit 55 is, for example, a monitor.

The storage unit 56 is connected to the clearance calculation device 51. The storage unit 56 stores a program for the clearance calculation device 51 to calculate the size of the gap S1. The storage unit 56 also stores the rotational speed of the rotor 14 and the intake gas temperature measured by the rotational speed sensor 52 and the temperature sensor 53. Further, the storage unit 56 stores the clearance value SC1 of the gap S1 calculated by the clearance calculation device 51.

The clearance calculation device 51 includes a data acquisition unit 61, a gas path temperature calculation unit 62, a metal temperature calculation unit 63, a deformation amount calculation unit 64, and an average clearance calculation unit 65.

The data acquisition unit 61 acquires the rotational speed measured by the rotational speed sensor 52 and the intake gas temperature measured by the temperature sensor 53.

The gas path temperature calculation unit 62 calculates a gas path temperature of the air passage (gas path) 28 based on the rotational speed and the intake gas temperature.

The metal temperature calculation unit 63 performs an unsteady heat transfer analysis using a stationary body heat transfer analysis model, a rotating body heat transfer analysis model, and a rotor blade heat transfer analysis model using the gas path temperature as a boundary condition. The metal temperature calculation unit 63 calculates temperature changes of the inner casing 22 on the stationary body side and the rotor 14 and the rotor blades 25 on the rotating body side by performing the unsteady heat transfer analysis.

The deformation amount calculation unit 64 calculates deformation amounts of the inner casing 22, the rotor 14, and the rotor blades 25 based on temperature changes of the inner casing 22 on the stationary body side and the rotor 14 and the rotor blades 25 on the rotating body side.

The average clearance calculation unit 65 calculates the clearance value SC1 of the gap S1 between the inner casing 22 and the rotor blades 25 based on the deformation amounts of the inner casing 22, the rotor 14, and the rotor blades 25.

### Low-Dimensional Unsteady Heat Transfer Analysis Model

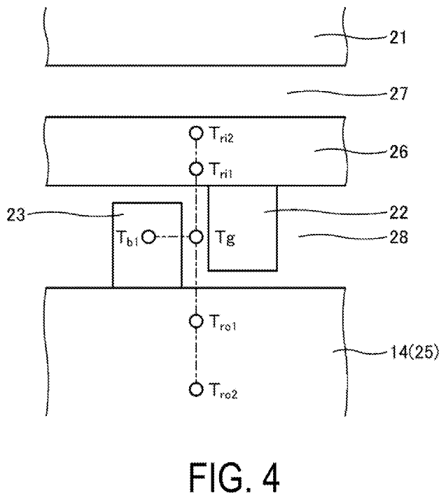

FIG. 4 is a schematic diagram illustrating a low-dimensional unsteady heat transfer analysis model.

FIG. 4 is an example of an analysis mesh of the low-dimensional unsteady heat transfer analysis model. As illustrated in FIG. 4, a stationary body heat transfer analysis model, a rotating body heat transfer analysis model, and a rotor blade heat transfer analysis model are set as the low-dimensional unsteady heat transfer analysis model. The stationary body heat transfer analysis model, the rotating body heat transfer analysis model, and the rotor blade heat transfer analysis model use a gas path temperature Tg as a boundary condition.

In the stationary body heat transfer analysis model, the nodes of the mesh are one measurement point at which the gas path temperature Tg is measured and two points at which inner casing temperatures Tᵣᵢ₁ and Tᵣᵢ₂ are measured. The measurement point of the gas path temperature Tg and the measurement points of the inner casing temperatures Tᵣᵢ₁ and Tᵣᵢ₂ are set at positions shifted from each other in the radial direction of the casing 21 and the rotor 14. In this case, the inner casing temperatures Tᵣᵢ₁ and Tᵣᵢ₂ may be measured at one point, or at three or more points.

In the rotating body heat transfer analysis model, the nodes of the mesh are one point at which the gas path temperature Tg is measured and two points at which rotor temperatures Tᵣₒ₁ and Tᵣₒ₂ are measured. The measurement point of the gas path temperature Tg and the measurement points of the rotor temperatures Tᵣₒ₁ and Tᵣₒ₂ are set at positions shifted from each other in the radial direction of the casing 21 and the rotor 14. In this case, the rotor temperatures Tᵣₒ₁ and Tᵣₒ₂ may be measured at one point or three or more points.

In the rotor blade heat transfer analysis model, the nodes of the mesh are one point at which the gas path temperature Tg is measured and one point at which a rotor blade temperature T_{b1} is measured. The measurement point of the gas path temperature Tg and the measurement point of the rotor blade temperature T_{b1} are set at positions shifted from each other in the axial direction of the casing 21 and the rotor 14. In this case, the rotor blade temperature T_{b1} may be measured at two or more points.

Since the rotor blades 25 are smaller in size and volume than components such as the casing 21 and the rotor 14, the low-dimensional unsteady heat transfer analysis model may be composed of the stationary body heat transfer analysis model and the rotating body heat transfer analysis model excluding the rotor blade heat transfer analysis model. When the rotor blade heat transfer analysis model is excluded, the rotor blade temperature T_{b1} is assumed to be equivalent to the gas path temperature Tg.

As a feature of modeling by the low-dimensional unsteady heat transfer analysis model, the stationary body heat transfer analysis model and the rotating body heat transfer analysis model only need to express heat transfer in the radial direction of the casing 21 and the rotor 14 which greatly contribute to the gap S1. Thus, in the low-dimensional unsteady heat transfer analysis model, it is possible to achieve dimension reduction of the model by omitting the heat transfer in the axial direction and the circumferential direction of the casing 21 and the rotor 14.

In addition, by setting the stationary body heat transfer analysis model, the rotating body heat transfer analysis model, and the rotor blade heat transfer analysis model as the low-dimensional unsteady heat transfer analysis model, it is possible to express a complicated change history of the clearance including a response delay in a transient state of the gas turbine 10. In this case, in order for the clearance calculation device 51 to realize real-time calculation and future estimation, it is appropriate to set the number of nodes in the components to about 2 to 100.

Note that, in the stationary body heat transfer analysis model, the nodes on the stationary body side are the measurement points of the inner casing temperatures Tᵣᵢ₁ and Tᵣᵢ₂ at the inner casing 22, but the nodes are not limited to being located at the inner casing 22, and only need to be located on the stationary body side. That is, the nodes on the stationary body side may be provided at a member on the stationary body side facing the air passage (gas path) 28. In addition, in the rotating body heat transfer analysis model, the nodes on the rotating body side are the measurement points of the rotor temperatures Trᵣₒ₁ and Tᵣₒ₂ at the rotor 14, but the measurement range includes the rotor 14 and the turbine disk 27, and the like, as the rotating body.

### Average Clearance

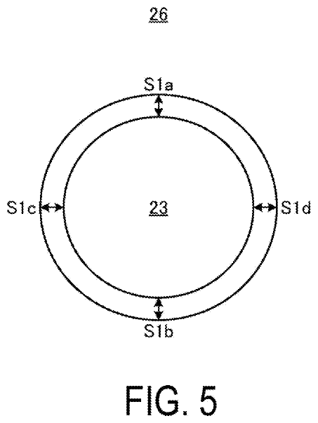

FIG. 5 is an explanatory diagram for describing an average clearance. Note that the plurality of rotor blades 25 are fixed to the rotor 14 at intervals in the circumferential direction, and FIG. 5 is a schematic diagram in which the plurality of rotor blades 25 are integrated.

As illustrated in FIGS. 3 and 5, in the clearance calculation device 51, the average clearance calculation unit 65 calculates the clearance value SC1 of the gap S1 between the inside surface of the inner casing 22 and the tip surface of the rotor blade 25 based on the deformation amounts of the inner casing 22, the rotor 14, and the rotor blade 25. In this case, the average clearance calculation unit 65 calculates an average clearance value SC1av that is an average value of clearance values SC1a, SC1b , SC1c, and SC1d of gaps S1a, S1b, S1c, and S1d which are gaps S1 between the inner casing 22 and the rotor blade 25 at a plurality of different positions in the circumferential direction.

That is, the clearance value SC1a is the size of an upper gap S1a between the inner casing 22 and the rotor blade 25, the clearance value SC1b is the size of a lower gap S1b between the inner casing 22 and the rotor blade 25, the clearance value SC1c is the size of a left gap S1c between the inner casing 22 and the rotor blade 25, and the clearance value SC1d is the size of a right gap S1d between the inner casing 22 and the rotor blade 25. The average clearance value SC1av is calculated according to the following equation (1). The number of positions of the gaps S1 for calculating the average clearance value SC1av of the gaps S1 is not limited to four.

SC1av=(SC1a=SC1b=SC1c=SC1d)/4 (1)

### Clearance Estimation Method

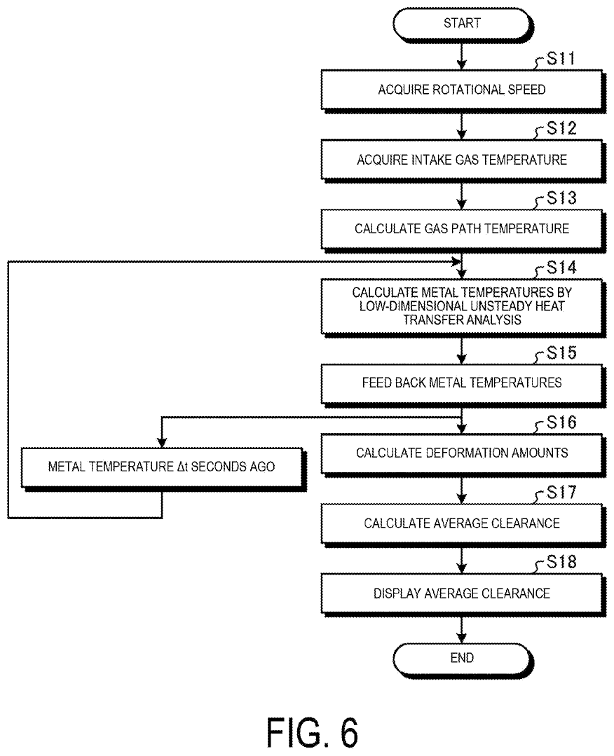

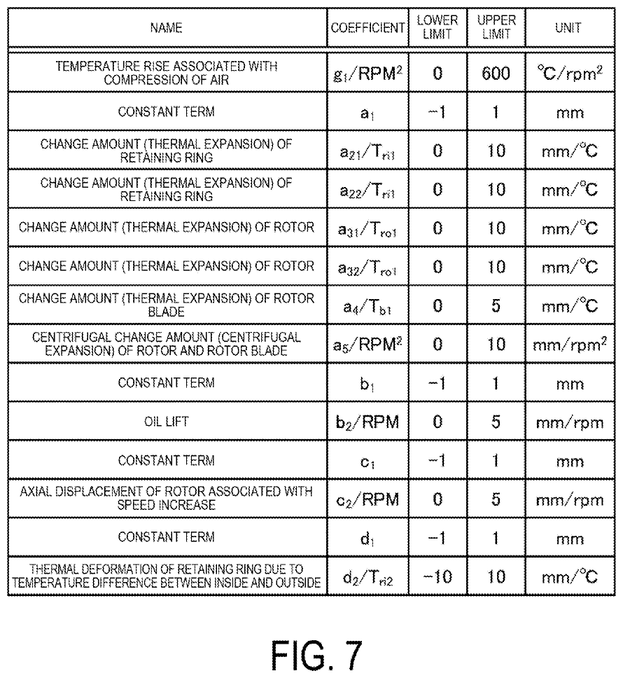

FIG. 6 is a flowchart illustrating a clearance estimation method according to the first embodiment, and FIG. 7 is an explanatory diagram showing ranges of coefficients in optimization.

As illustrated in FIGS. 3 and 6, in step S11, the data acquisition unit 61 acquires a rotational speed of the rotor 14 measured by the rotational speed sensor 52. In step S12, the data acquisition unit 61 acquires an intake gas temperature measured by the temperature sensor 53. In step S13, the gas path temperature calculation unit 62 calculates a gas path temperature Tg of the air passage (gas path) 28 according to the following equation (2) based on the rotational speed RPM and the intake gas temperature T₁. Note that g₁ is a coefficient obtained by optimization so as to reproduce an actual measurement value of the gas path temperature Tg.

Tg=T₁+g₁·RPM² (2)

In the case of application to the turbine 13, the gas path temperature Tg of a combustion gas pass (gas path) is calculated according to the following equation.

Tg=g₂·T1T
T1T: Gas temperature at a turbine inlet

In step S14, the metal temperature calculation unit 63 calculates the temperatures of the inner casing 22, the rotor 14, and the rotor blade 25 by performing the unsteady heat transfer analysis using the gas path temperature as a boundary condition. That is, the metal temperature calculation unit 63 calculates the temperature of the inner casing 22 by the stationary body heat transfer analysis model using the gas path temperature as a boundary condition. The metal temperature calculation unit 63 calculates the temperature of the rotor 14 by the rotating body heat transfer analysis model using the gas path temperature as a boundary condition. The metal temperature calculation unit 63 calculates the temperature of the rotor blade 25 by the rotor blade heat transfer analysis model using the gas path temperature as a boundary condition.

In step S15, the metal temperature calculation unit 63 feeds back the calculated temperatures of the inner casing 22, the rotor 14, and the rotor blade 25. That is, in steps S14 and S15, the metal temperature calculation unit 63 outputs and feeds back the temperatures of the inner casing 22, the rotor 14, and the rotor blade 25 every Δt seconds by performing an analysis assuming an unsteady state in which the temperatures change with the lapse of time through the unsteady heat transfer analysis, and performs a heat transfer analysis using the temperatures of the inner casing 22, the rotor 14, and the rotor blade 25 every Δt seconds. In the heat transfer analysis performed by the metal temperature calculation unit 63, metal temperatures at the current time are calculated using metal temperatures at the previous time step, and the deformation amounts of the inner casing 22, the rotor 14, and the rotor blade 25 are calculated based on the metal temperatures and the rotational speed according to an equation described later.

In step S16, the deformation amount calculation unit 64 calculates a change amount (expansion amount in the radial direction) E1 of the inner casing 22, a change amount (expansion amount in the radial direction) E2 of the rotor 14, and a deformation amount (expansion amount in the radial direction) E3 of the rotor blade 25 based on the temperature changes of the inner casing 22, the rotor 14, and the rotor blade 25 according to the following equations (3), (4), and (5), respectively. Further, a deformation amount (expansion amount in the radial direction) E4 of the rotor 14 and the rotor blade 25 due to a centrifugal force is calculated according to the following equation (6).

E1=a₂₁·Tᵣᵢ₁+a₂₂·Tᵣᵢ₂ (3)

E2=a₃₁·Tᵣₒ₁+a₃₂·Tᵣₒ₂ (4)

E3=a₄·T_{b1} (5)

E4=a₅·RPM² (6)

In step S17, the average clearance calculation unit 65 calculates the average clearance value SC1av of the gap S1 between the inner casing 22 and the rotor blade 25 according to the following equation (7) based on the change amount E1 of the inner casing 22, the change amount E2 of the rotor 14, the deformation amount E3 of the rotor blade 25, and the deformation amount E4 the rotor 14 and the rotor blade 25 due to the centrifugal force.

SC1av=a₁+E1−E2−E3−E4 (7)

In step S18, the display unit 55 displays the calculated average clearance value SC1av of the gap S1.

Meanwhile, the clearance calculation device 51 identifies various types of coefficients when performing the low-dimensional unsteady heat transfer analysis model and the plurality of calculations described above. That is, as illustrated in FIG. 3, the clearance estimation system 50 includes a coefficient identification unit 57. The coefficient identification unit 57 is connected to the clearance calculation device 51. The coefficient identification unit 57 outputs each of the identified coefficients to the clearance calculation device 51.

That is, the coefficient identification unit 57 classifies the operating state of the gas turbine 10 into a plurality of operating states, and identifies each of the coefficients used for the calculation of the clearance using various types of identification methods. In this case, by dividing the gas turbine 10 into response surfaces for the respective operating states, a response surface shape facilitating optimization is obtained. Here, the operating state of the gas turbine 10 is classified into, for example, a turning operation, a low-load operation from start-up to an intermediate load, and an operation in a rated load state.

The coefficient identification methods include, for example, an identification method based on a high-dimensional simulation, an identification method based on a metal temperature measurement, and an identification method based on a clearance measurement. The identification method based on a high-dimensional simulation is a method in which a high-dimensional simulation (heat transfer analysis, structural analysis, or the like) strictly simulating the state of the gas turbine from a stop state to an operating state is performed so as to optimize a coefficient of a calculation formula that reproduces the result of the simulation. The identification method based on a metal temperature measurement is an identification method in which the metal temperature of each structural member of the gas turbine is measured so as to optimize a coefficient of a low-dimensional unsteady heat transfer analysis model that reproduces a temperature history, and a coefficient of a calculation formula of a change amount is separately identified by a high-dimensional simulation or the like.

The identification method based on a clearance measurement is a method in which local clearance values are measured by a verification test or a test run so as to optimize coefficients of a low-dimensional unsteady heat transfer analysis model and a change amount calculation formula that reproduce a local clearance value history. In this case, each coefficient used for the calculation of the clearance value is identified by performing optimization such that a difference between the clearance value of the gap S1 calculated by the average clearance calculation unit 65 and an actually-measured clearance value of the gap S1 is minimized.

FIG. 7 is an explanatory diagram showing ranges of coefficients in optimization. As illustrated in FIG. 7, specific ranges of coefficients are set.

### Second Embodiment

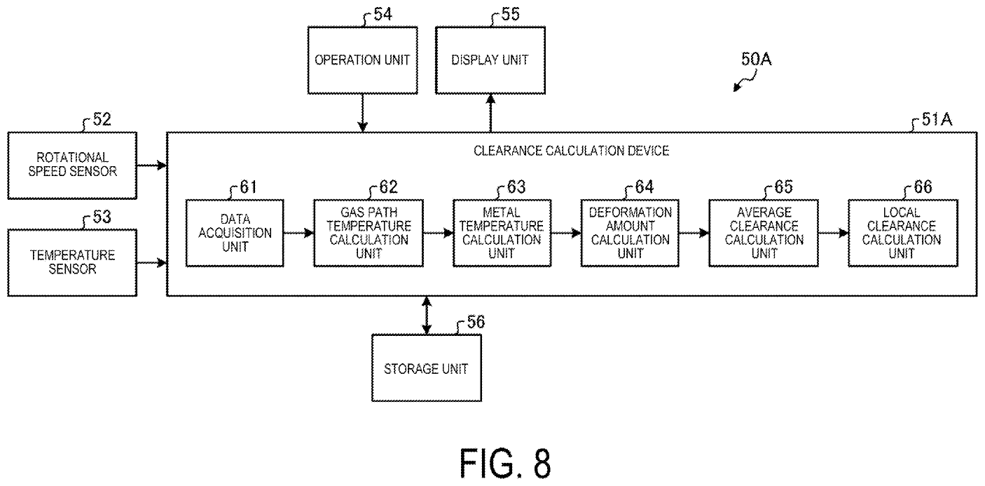

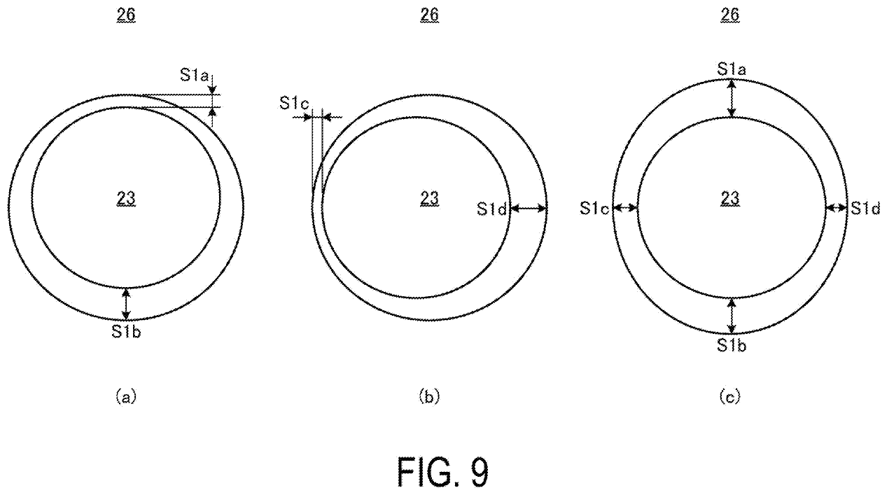

FIG. 8 is a schematic configuration diagram illustrating a clearance estimation system according to a second embodiment, and FIG. 9 is an explanatory diagram for describing local clearance values. Members having the same functions as those of the above-described first embodiment are denoted by the same reference signs, and detailed description thereof will be omitted.

As illustrated in FIG. 8, a clearance estimation system 50A includes a clearance calculation device 51A, the rotational speed sensor 52, the temperature sensor 53, the operation unit 54, the display unit 55, and the storage unit 56. The rotational speed sensor 52, the temperature sensor 53, the operation unit 54, the display unit 55, and the storage unit 56 are the same as those in the first embodiment.

The clearance calculation device 51A calculates a clearance value of a gap S1 between the inside surface of the inner casing 22 on the casing 21 side and a tip surface of the rotor blade 25 on the rotor 14 side.

The clearance calculation device 51A includes the data acquisition unit 61, the gas path temperature calculation unit 62, the metal temperature calculation unit 63, the deformation amount calculation unit 64, the average clearance calculation unit 65, and a local clearance calculation unit 66. The data acquisition unit 61, the gas path temperature calculation unit 62, the metal temperature calculation unit 63, the deformation amount calculation unit 64, and the average clearance calculation unit 65 are the same as those in the first embodiment.

The local clearance calculation unit 66 calculates local clearance values of the gap S1 between the inner casing 22 and the rotor blade 25 at a plurality of positions based on the deformation amounts of the inner casing 22, the rotor 14, and the rotor blade 25.

### Local Clearance

FIG. 9 is an explanatory diagram for describing local clearance values.

As illustrated in FIGS. 8 and 9, in the clearance calculation device 51A, the local clearance calculation unit 66 calculates the clearance values of the gap S1 between the inside surface of the inner casing 22 and the tip surface of the rotor blade 25 based on the deformation amounts of the inner casing 22, the rotor 14, and the rotor blade 25. In this case, the local clearance calculation unit 66 calculates local clearance values SC1a, SC1b, SC1c, and SC1d, that is, the sizes of gaps S1a, S1b, S1c, and S1d each of which is the gap S1 between the inner casing 22 and the rotor blades 25 at each of a plurality of different positions in the circumferential direction.

That is, a vertical deviation SC1ab, a horizontal deviation SC1cd, and an oval deformation SC1o of the local clearance values SC1a, SC1b, SC1c, and SC1d of the gaps S1a, S1b, S1c, and S1d are calculated according to the following equations (8), (9), and (10).

SC1ab=(SC1a+SC1b)/2 (8)

SC1cd=(SC1c+SC1d)/2 (9)

SC1o=((SC1a+SC1b)−(SC1c+SC1d))/4 (10)

### Clearance Estimation Method

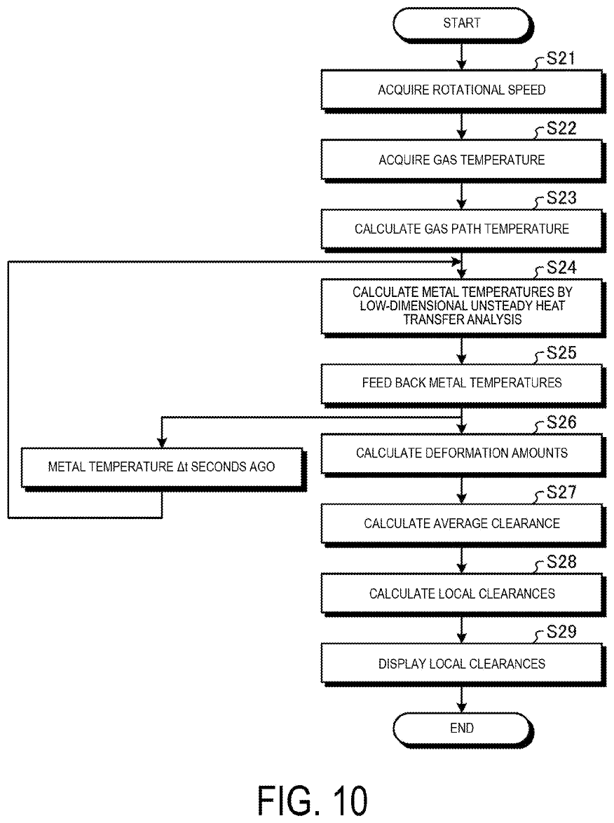

FIG. 10 is a flowchart illustrating a clearance estimation method according to the second embodiment.

As illustrated in FIGS. 8 and 10, processes in steps S21 to S27 are similar to processes in steps S11 to S17 in the first embodiment. In step S28, the local clearance calculation unit 66 calculates the local clearance values SC1a, SC1b, SC1c, and SC1d based on the average clearance value SC1av, the vertical deviation SC1ab, the horizontal deviation SC1cd, and the oval deformation SC1o.

First, the local clearance calculation unit 66 calculates the vertical deviation SC1ab, the horizontal deviation SC1cd, and the oval deformation SC1o according to the following equations (11), (12), and (13).

SC1ab=b₁−b₂·RPM (11)

SC1cd=c₁+c₂·RPM (12)

SC1o=d₁+d₂(Tᵣᵢ₂−Tᵣᵢ₁) (13)

Next, based on the average clearance value SC1av, the vertical deviation SC1ab, the horizontal deviation SC1cd, and the oval deformation SC1o, the local clearance calculation unit 66 calculates the local clearance values SC1a, SC1b, SC1c, and SC1d according to the following equations (14), (15), (16), and (17).

SC1a=SC1av+SC1ab+SC1o (14)

SC1b=SC1av−SC1ab+SC1o (15)

SC1c=SC1av+SC1cd−SC1o (16)

SC1d=SC1av+SC1cd−SC1o (17)

In step S29, the display unit 55 displays the calculated local clearance values SC1a, SC1b, SC1c, and SC1d of the gap S1.

### Third Embodiment

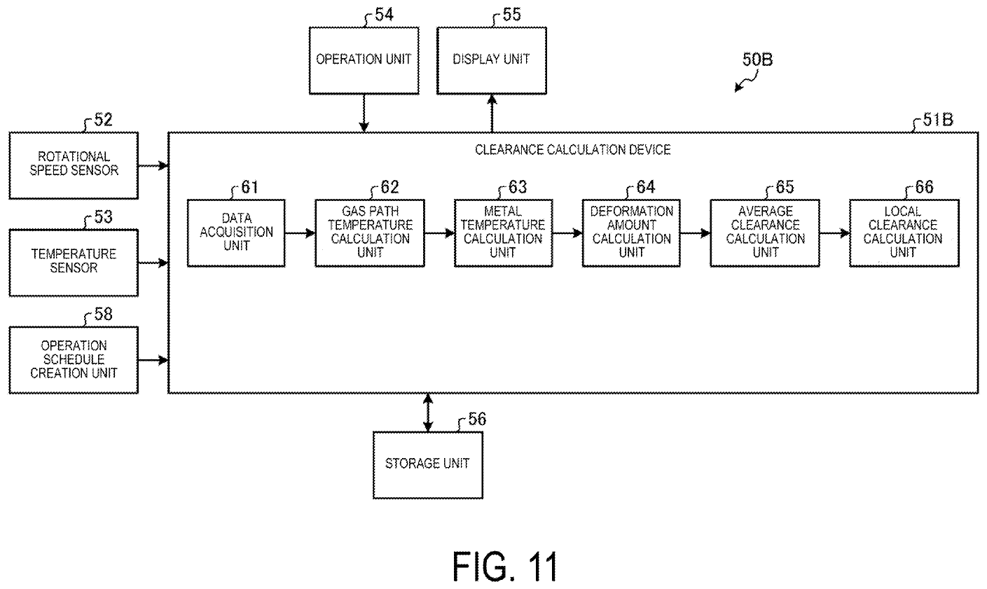

FIG. 11 is a schematic configuration diagram illustrating a clearance estimation system according to a third embodiment. Note that the same reference numerals are given to members having the same functions as the embodiments described above and detailed description thereof will be omitted.

As illustrated in FIG. 11, a clearance estimation system 50B includes a clearance calculation device 51B, the rotational speed sensor 52, the temperature sensor 53, the operation unit 54, the display unit 55, the storage unit 56, and an operation schedule creation unit 58. The rotational speed sensor 52, the temperature sensor 53, the operation unit 54, the display unit 55, and the storage unit 56 are the same as those in the first embodiment.

The operation schedule creation unit 58 creates an operation schedule of the gas turbine 10. The operation schedule is an operation schedule of the gas turbine 10, which is currently in a stopped state, from startup to rated operation, and then to stop. Note that the operation schedule is not limited to the operation from the startup to the rated operation of the gas turbine 10 that is currently in a stopped state, and may include the operations such as speed increase, load increase, and load change. The operation schedule creation unit 58 is connected to the clearance calculation device 51B and outputs the created operation schedule of the gas turbine 10 to the clearance calculation device 51B.

The clearance calculation device 51B calculates a clearance value of a gap S1 between the inside surface of the inner casing 22 on the casing 21 side and a tip surface of the rotor blade 25 on the rotor 14 side.

The clearance calculation device 51B includes the data acquisition unit 61, the gas path temperature calculation unit 62, the metal temperature calculation unit 63, the deformation amount calculation unit 64, the average clearance calculation unit 65, and the local clearance calculation unit 66. The gas path temperature calculation unit 62, the metal temperature calculation unit 63, the deformation amount calculation unit 64, the average clearance calculation unit 65, and the local clearance calculation unit 66 are the same as those in the second embodiment.

The data acquisition unit 61 acquires the operation schedule of the gas turbine 10 created by the operation schedule creation unit 58. The operation schedule of the gas turbine 10 includes a command value for rotational speed from the startup to the rated operation, and thus the data acquisition unit 61 acquires the command value for the rotational speed of the gas turbine 10 from the startup to the rated operation.

In addition, the data acquisition unit 61 acquires a past intake gas temperature of the gas turbine 10 from the startup to the rated operation. Past operation data of the gas turbine 10 is stored, for example, in the storage unit 56. The data acquisition unit 61 acquires operation state data, which is similar to the operation schedule acquired from the operation schedule creation unit 58, from the storage unit 56 so as to acquire the intake gas temperature at the time corresponding to the operating state data. The past intake gas temperature may be a value of one operation data or may be an average value of a plurality of operation data.

The gas path temperature calculation unit 62, the metal temperature calculation unit 63, the deformation amount calculation unit 64, the average clearance calculation unit 65, and the local clearance calculation unit 66 perform various types of calculations based on the command value for rotational speed included in the operation schedule and the past intake gas temperature acquired from the storage unit 56 so as to calculate an average clearance value and local clearance values of the gap S1 between the inner casing 22 and the rotor blade 25.

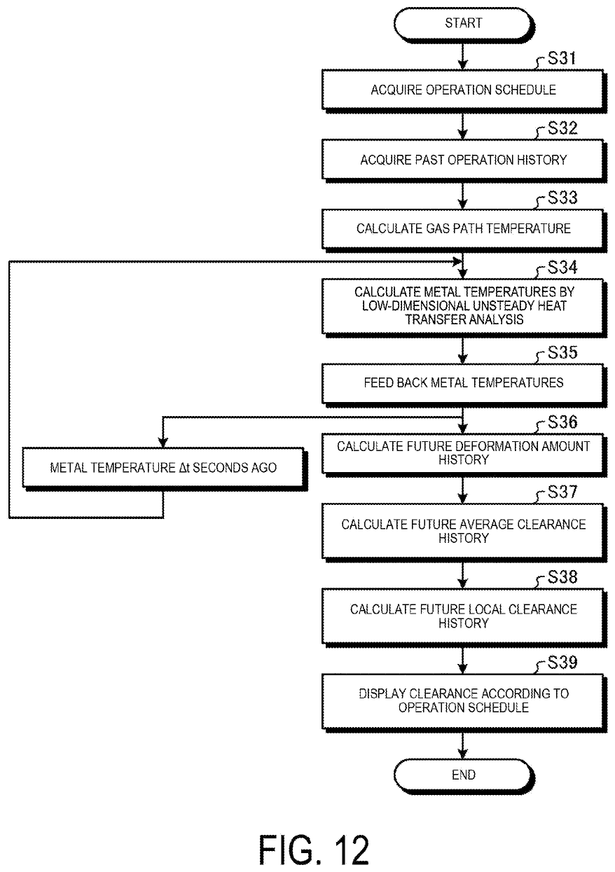

FIG. 12 is a flowchart illustrating a clearance estimation method according to the third embodiment.

As illustrated in FIGS. 11 and 12, in step S31, the data acquisition unit 61 acquires the operation schedule of the gas turbine 10 created by the operation schedule creation unit 58. In step S32, the data acquisition unit 61 acquires a past operation history of the gas turbine 10 stored in the storage unit 56. In step S33, the gas path temperature calculation unit 62 calculates a gas path temperature of the air passage (gas path) 28 based on the rotational speed and the intake gas temperature.

At this time, the rotational speed is the command value for rotational speed that changes during the operation from the startup to the rated operation of the gas turbine 10 in the future, and is included in the operation schedule. The intake gas temperature is a history of the intake gas temperature that changes during the operation from the startup to the rated operation of the gas turbine 10 in the past, and is included in the operation history. However, the intake gas temperature has a value close to an outside temperature, and thus is less likely to change depending on an operating state such as the startup, and changes with an increase in an air temperature from morning to daytime, for example. Therefore, for example, it may be assumed that the current temperature is kept, or a temperature according to a weather forecast may be adopted. The method of calculating the gas path temperature is the same as that in the first embodiment.

In step S34, the metal temperature calculation unit 63 calculates the temperatures of the inner casing 22, the rotor 14, and the rotor blade 25 by performing the unsteady heat transfer analysis using the gas path temperature as a boundary condition. In step S35, the metal temperature calculation unit 63 feeds back the calculated temperatures of the inner casing 22, the rotor 14, and the rotor blade 25. In step S36, the deformation amount calculation unit 64 calculates a change amount (expansion amount in the radial direction) of the inner casing 22, a change amount (expansion amount in the radial direction) of the rotor 14, and a deformation amount (expansion amount in the radial direction) of the rotor blade 25 based on the temperature changes of the inner casing 22, the rotor 14, and the rotor blade 25. Further, a deformation amount (expansion amount in the radial direction) of the rotor 14 and the rotor blade 25 due to a centrifugal force is calculated.

The processes in steps S34, S35, and S36 are the same as those in the first embodiment. However, the metal temperature calculation unit 63 calculates future temperatures of the inner casing 22, the rotor 14, and the rotor blade 25 according to the operation schedule. The deformation amount calculation unit 64 calculates future deformation amounts of the inner casing 22, the rotor 14, and the rotor blade 25 according to the operation schedule.

In step S37, the average clearance calculation unit 65 calculates a future average clearance value of the gap S1 between the inner casing 22 and the rotor blade 25 according to the operation schedule based on the deformation amounts of the inner casing 22, the rotor 14, and the rotor blade 25. In step S38, the local clearance calculation unit 66 calculates future local clearance values according to the operation schedule based on the average clearance value, the vertical deviation, the horizontal deviation, and the oval deformation. The methods of calculating the average clearance value and the local clearance values are the same as those in the second embodiment.

In step S39, the display unit 55 displays the calculated average clearance value and the calculated local clearance values of the gap S1.

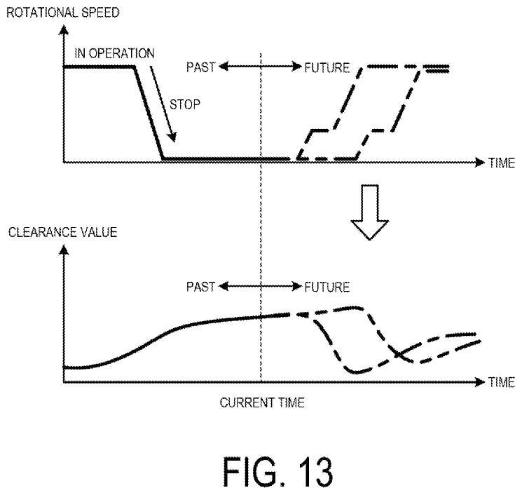

FIG. 13 is a graph illustrating variations in clearance according to the operation schedule.

As illustrated in FIG. 13, for example, at the current time, the gas turbine 10 is in a stopped state, the rotational speed is 0, and the clearance value is a predetermined value. The left side of the current time of FIG. 13 indicates past operation data of the gas turbine 10, and the right side of FIG. 3 is future estimated operation data estimated according to the operation schedule of the gas turbine 10.

That is, the clearance calculation device 51B estimates the clearance value between the inner casing 22 and the rotor blade 25 relative to the changes in the rotational speed of the rotor 14 according to the operation schedule and the past operation history of the gas turbine 10. Here, the estimated operation data indicated by a dashed-dotted line in FIG. 13 indicates the occurrence of a period in which the clearance value temporarily becomes small. Thus, by changing the operation schedule of the gas turbine 10 as indicated by a dashed-two dotted line in FIG. 13, it is possible to suppress the occurrence of the period in which the clearance value becomes small. Accordingly, it is possible to optimally determine a timing and a method at/in which the gas turbine 10 can be safely started.

### Modification Example

In the embodiments described above, the gas path temperature is calculated based on the rotational speed of the rotating body and the gas temperature, the deformation amount is calculated based on the metal temperature changes obtained by performing the unsteady heat transfer analysis, and the clearance value is calculated based on the deformation amount, but the disclosure is not limited to this method. For example, machine learning may be used in combination the method of calculating the clearance value described above so as to improve the accuracy of estimating the clearance value.

For example, the machine learning is performed by using local clearance values measured in a verification test or a test run of the gas turbine 10 as objective variables, and parameters related to an operating state such as local clearance values estimated by a heat transfer analysis and calculation equations, a rotational speed, and an output of the gas turbine 10 as explanatory variables. Alternatively, a difference between the measured local clearance values and the estimated (calculated) local clearance values may be used as objective variables, and parameters related to an operating state such as a rotational speed and an output of the gas turbine 10 may be used as explanatory variables. As a machine learning model, a model that does not consider an operation history, such as a neural network or support vector regression, can be used. When there is sufficient learning data, a machine learning model that consider an operation history such as a recurrent neural network or a long short-term memory (LSTM) can be used.

### Actions and Effects of Present Embodiment

A clearance calculation device according to a first aspect includes: the data acquisition unit 61 configured to acquire a rotational speed of the rotor (rotating body) 14 and a gas temperature of a gas taken in the air passage (gas path) 28; the gas path temperature calculation unit 62 configured to calculate a gas path temperature of the air passage 28 based on the rotational speed and the gas temperature; the metal temperature calculation unit 63 configured to calculate temperatures of the inner casing 22 and the rotor 14 by performing an unsteady heat transfer analysis using a stationary body heat transfer analysis model and a rotating body heat transfer analysis model using the gas path temperature as a boundary condition; the deformation amount calculation unit 64 configured to calculate deformation amounts of the inner casing 22 and the rotor 14 based on temperature changes of the inner casing 22 and the rotor 14; and the clearance calculation units 65 and 66 configured to calculate clearance values between the inner casing 22 and the rotor blade 25 based on the deformation amounts.

According to the clearance calculation device of the first aspect, by performing the unsteady heat transfer analysis using the gas path temperature as a boundary condition, the number of sensors for measuring the temperatures of the structural members of the gas turbine 10, a gas temperature, a pressure, and the like is reduced. Thus, it is possible to suppress an increase in product cost and to reduce a computation load.

In the clearance calculation device according to a second aspect, the nodes of the mesh in the stationary body heat transfer analysis model are set at a point in the air passage 28 and at one or more points in the inner casing 22 which are shifted from each other in the radial direction. Accordingly, it is possible to estimate the gas temperature of the air passage 28 by simple processing.

In the clearance calculation device according to a third aspect, the nodes of the mesh in the rotating body heat transfer analysis model are set at a point in the air passage 28 and at one or more points in the rotor 14 which are shifted from each other in the radial direction. Accordingly, it is possible to estimate the gas temperature of the air passage 28 by simple processing.

In the clearance calculation device according to a fourth aspect, the metal temperature calculation unit 63 calculates the temperature of the stator vane 24 or the rotor blade 25 by performing an unsteady heat transfer analysis using a stator vane heat transfer analysis model or a rotor blade heat transfer analysis model using the gas path temperature as a boundary condition. Accordingly, it is possible to estimate the gas temperature of the air passage 28 with high accuracy.

The clearance calculation device according to a fifth aspect includes the average clearance calculation unit 65 configured to calculate an average clearance value that is an average value of clearance values between the inner casing 22 and the rotor blade 25 at a plurality of different positions in the circumferential direction. Accordingly, the clearance value between the inner casing 22 and the rotor blade 25 can be estimated in an early stage.

The clearance calculation device according to a sixth aspect includes the local clearance calculation unit 66 configured to calculate local clearance values that are clearance values between the inner casing 22 and the rotor blade 25 at different positions in the circumferential direction. Accordingly, the clearance value between the inner casing 22 and the rotor blade 25 can be estimated in detail.

The clearance calculation device according to a seventh aspect includes the coefficient identification unit 57 configured to identify coefficients used for calculating the clearance value by classifying the operating state of the gas turbine 10 into a plurality of operating states, and by performing optimization such that differences between clearance values calculated by the clearance calculation units 65 and 66 and an actually-measured clearance value is minimized. Accordingly, the clearance value between the inner casing 22 and the rotor blade 25 can be estimated with high accuracy.

In the clearance calculation device according to an eighth aspect, the data acquisition unit 61 acquires the operation schedule of the gas turbine 10, and the gas path temperature calculation unit 62 calculates the gas path temperature of the air passage 28 based on the rotational speed of the rotor 14 and the intake gas temperature according to the operation schedule. Accordingly, the clearance value between the inner casing 22 and the rotor blade 25 according to the operation schedule can be estimated.

The clearance calculation method according to a ninth aspect includes: a step of acquiring a rotational speed of the rotor (rotating body) 14 and a gas temperature of a gas taken in the air passage (gas path) 28; a step of calculating a gas path temperature of the air passage 28 based on the rotational speed and the gas temperature; a step of calculating temperatures of the inner casing 22 and the rotor 14 by performing an unsteady heat transfer analysis using a stationary body heat transfer analysis model and a rotating body heat transfer analysis model using the gas path temperature as a boundary condition; a step of calculating deformation amounts of the inner casing 22 and the rotor 14 based on temperature changes of the inner casing 22 and the rotor 14; and a step of calculating a clearance value between the inner casing 22 and the rotor blade 25 based on the deformation amounts. Accordingly, the number of sensors for measuring the temperatures of the structural members of the gas turbine 10, a gas temperature, a pressure, and the like is reduced. Thus, it is possible to suppress an increase in product cost and to reduce a computation load.

Note that, in the embodiments described above, the size of the gap (clearance) S1 between the inner casing 22 on the casing 21 side and the rotor blade 25 on the rotor side is estimated. However, the size of the gap (clearance) S2 between the tip portion of the stator vane 24 and the platform 26 on the rotor 14 side may be estimated. In that case, a stator vane heat transfer analysis model is used in substitution for the rotor blade heat transfer analysis model.

Further, in the embodiments described above, the rotary machine is described as the gas turbine 10 and the compressor 11, but the rotary machine may be, for example, the turbine 13, may be a steam turbine, or may be another rotary machine.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A clearance calculation device for a rotary machine in which a rotating body is rotatably supported by a stationary body and a gas path is formed between the stationary body and the rotating body, the clearance calculation device comprising:
a data acquisition unit configured to acquire a rotational speed of the rotating body and a gas temperature of a gas taken in the gas path;
a gas path temperature calculation unit configured to calculate a gas path temperature of the gas path based on the rotational speed and the gas temperature;
a metal temperature calculation unit configured to calculate temperatures of the stationary body and the rotating body by performing an unsteady heat transfer analysis using a stationary body heat transfer analysis model and a rotating body heat transfer analysis model using the gas path temperature as a boundary condition;
a deformation amount calculation unit configured to calculate deformation amounts of the stationary body and the rotating body based on temperature changes of the stationary body and the rotating body; and
a clearance calculation unit configured to calculate a clearance value between the stationary body and the rotating body based on the deformation amounts.

2. The clearance calculation device according to claim 1, wherein nodes of a mesh in the stationary body heat transfer analysis model are set at a point in the gas path and at one or more points in the stationary body, these points being shifted from each other in a radial direction of the stationary body.

3. The clearance calculation device according to claim 1, wherein nodes of a mesh in the rotating body heat transfer analysis model are set at a point in the gas path and at one or more points in the rotating body, these points being shifted from each other in a radial direction of the rotating body.

4. The clearance calculation device according to claim 1, wherein
a plurality of stator vanes extending toward the rotating body is disposed at an inner peripheral portion of the stationary body at intervals in a circumferential direction,
a plurality of rotor blades extending toward the stationary body is disposed at an outer peripheral portion of the rotating body at intervals in a circumferential direction, and
the metal temperature calculation unit calculates a temperature of the stator vanes or the rotor blades by performing an unsteady heat transfer analysis using a stator vane heat transfer analysis model or a rotor blade heat transfer analysis model using the gas path temperature as a boundary condition.

5. The clearance calculation device according to claim 1, wherein the clearance calculation unit calculates an average clearance value being an average value of clearance values between the stationary body and the rotating body at a plurality of different positions in a circumferential direction.

6. The clearance calculation device according to claim 1, wherein the clearance calculation unit calculates local clearance values being clearance values between the stationary body and the rotating body at different positions in a circumferential direction.

7. The clearance calculation device according to claim 1, further comprising a coefficient identification unit configured to identify a coefficient used for calculating a clearance value by classifying an operating state of the rotary machine into a plurality of operating states and performing optimization such that a difference between a clearance value calculated by the clearance calculation unit and an actually-measured clearance value is minimized.

8. The clearance calculation device according to claim 1, wherein
the data acquisition unit acquires an operation schedule of the rotary machine, and
the gas path temperature calculation unit calculates the gas path temperature of the gas path based on the rotational speed and the gas temperature according to the operation schedule.

9. A clearance calculation method for a rotary machine in which a rotating body is rotatably supported by a stationary body and a gas path is formed between the stationary body and the rotating body, the clearance calculation method comprising:
acquiring a rotational speed of the rotating body and a gas temperature of a gas taken in the gas path;
calculating the gas path temperature of the gas path based on the rotational speed and the gas temperature;
calculating temperatures of the stationary body and the rotating body by performing an unsteady heat transfer analysis using a stationary body heat transfer analysis model and a rotating body heat transfer analysis model using the gas path temperature as a boundary condition;
calculating deformation amounts of the stationary body and the rotating body based on temperature changes of the stationary body and the rotating body; and
calculating a clearance value between the stationary body and the rotating body based on the deformation amounts.
